(19) United States
(12) Patent Application Publication
(10) Pub. No.: US 2008/0319957 A1
(43) Pub. Date: Dec. 25, 2008

(54) EXTENSIBLE COMMAND TREES FOR ENTITY DATA MODEL PLATFORM

(75) Inventors: Subramanian Muralidhar, Bellevue, WA (US); Simon Cavanagh, Redmond, WA (US); Steve Starck, Bothell, WA (US); Sean B. House, Seattle, WA (US); Fabio Meireles Fernandez Valbuena, Bellevue, WA (US); Katica Iceva, Kirkland, WA (US); Ramesh Nagarajan, Seattle, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/764,851

(22) Filed: Jun. 19, 2007

(51) Int. Cl. G06F 17/30

(52) U.S. Cl. 707/4; 707/3; 707/E17.012

(57) ABSTRACT

Systems and methods that provide for a canonical representation in a structured form of a query, against a data model platform. A parser component can parse the SQL query to generate the abstract class that represent the query (command tree). Moreover, a view generation component can supply a mapping between a rich structure (e.g., on the client side) and the relational side. Accordingly, a query can be represented by an abstract class in form of a tree structure with nodes, which has metadata tied therewith.

### BACKGROUND

Data has become an important asset in almost every application, whether it is a Line-of-Business (LOB) application utilized for browsing products and generating orders, or a Personal Information Management (PIM) application used for scheduling a meeting between people. Applications perform both data access/manipulation and data management operations on the application data. Typical application operations query a collection of data, fetch the result set, execute some application logic that changes the state of the data, and finally, persist the data to the storage medium.

Traditionally, client/server applications relegated the query and persistence actions to database management systems (DBMS), deployed in the data tier. If data-centric logic, it is coded as stored procedures in the database system. The database system operated on data in terms of tables and rows, and the application, in the application tier, operated on the data in terms of programming language objects (e.g., Classes and Structs). The mismatch in data manipulation services (and mechanisms) in the application and the data tiers was tolerable in the client/server systems. However, with the advent of the web technology (and Service Oriented Architectures) and with wider acceptance of application servers, applications are becoming multi-tier, and more importantly, data is now present in every tier.

In such tiered application architectures, data is manipulated in multiple tiers. In addition, with hardware advances in addressability and large memories, more data is becoming memory resident. Applications are also dealing with different types of data such as objects, files, and XML (eXtensible Markup Language) data, for example.

In hardware and software environments, the need for rich data access and manipulation services well-integrated with the programming environments is increasing. One conventional implementation introduced to address the aforementioned problems is a data platform. The data platform provides a collection of services (mechanisms) for applications to access, manipulate, and manage data that is well integrated with the application programming environment. In general, such conventional architecture fail to adequately supply: complex object modeling, rich relationships, the separation of logical and physical data abstractions, query rich data model concepts, active notifications, better integration with middle-tier infrastructure, and the like.

### SUMMARY

The following presents a simplified summary in order to provide a basic understanding of some aspects described herein. This summary is not an extensive overview of the claimed subject matter. It is intended to neither identify key or critical elements of the claimed subject matter nor delineate the scope thereof. Its sole purpose is to present some concepts in a simplified form as a prelude to the more detailed description that is presented later.

The subject innovation provides for a canonical representation in a structured form of a query, against a data model platform such as a base class library that is employed to access data in a relational database system (e.g. an ADO.net framework). Accordingly, a query can be represented by an abstract class in form of a tree structure with nodes that has metadata tied therewith. Such tree structure functions as a canonical tree representation of the query, which further enables translation into Structured Query Language (SQL) and/or facilitates direct comprehension by an associated database (e.g., typically without translation into a textual format).

In accordance with a further aspect of the subject innovation, a parser component can parse the SQL query to generate the abstract class that represent the query (command tree). Moreover, a view generation component can supply a mapping between a rich structure (e.g., on the client side) and the relational side. Hence, a standard manner of query representation is provided to generate an SQL for the .NET framework, for example. In addition, a tracking component can track changes to the command tree to indicate a last time modification occurred thereon (e.g., via a monotonically increasing version number.) Accordingly, the canonical tree of the subject innovation represents an object model representation of a query in a given metadata space that can be employed to represent Query, Update, Insert and Delete commands.

In a related aspect, the tree representation of the subject innovation can be employed for applications Data Manipulation Language (DML), wherein the canonical tree represents an object model representation of a query in a given metadata space—which can be employed to represent Query, Update, Insert and Delete commands. The tree is the canonical representation of the queries and DML, wherein metadata associated with the tree can interpret the tree formulation, so that queries can be readily manipulated (as opposed to using the textual form that is typically employed.)

According to a methodology of the subject innovation, a query can be initially parsed to obtain a plurality of nodes that form canonical representation as a structured form of the query. Subsequently, the nodes can represent various relational and Entity constructs and operations such as expressions. Typically, an expression forms a building block for the tree structure of the subject innovation, and can represent a computation including constants, variables, functions, constructors and standard relational operators like filter, join, and the like—(every expression can have a datatype that represents the type of the result produced by that expression.) Next, the generated command tree can be passed, and forwarded to the view generation component that accesses metadata as needed to validate and update the command tree with appropriate metadata.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 illustrates a block diagram of a canonical representation in a structured form of a query, in accordance with an aspect of the subject innovation.

FIG. 2 illustrates a data model platform that implements the canonical representation of the subject innovation.

FIG. 3 illustrates a parser component that facilitates formation of the canonical representation in accordance with an aspect of the subject innovation.

FIG. 4 illustrates a view generation component and a tracking component that interact with a canonical representation of the subject innovation.

FIG. 5 illustrates a methodology for representing a query according to a particular aspect of the subject innovation.

FIG. 6 illustrates a related methodology for an exemplary query execution according to a further aspect of the subject innovation.

FIG. 7 illustrates an exemplary implementation of an abstract class that represents the query (command tree) in accordance with an aspect of the subject innovation.

FIG. 8 illustrates an artificial intelligence component that facilitates generation of a tree structure, to represents query in accordance with a particular aspect of the subject innovation.

FIG. 9 illustrates an exemplary environment for implementing various aspects of the subject innovation.

FIG. 10 is a schematic block diagram of a sample-computing environment that can be employed for a canonical tree representation according to an aspect of the subject innovation.

### DETAILED DESCRIPTION

The various aspects of the subject innovation are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

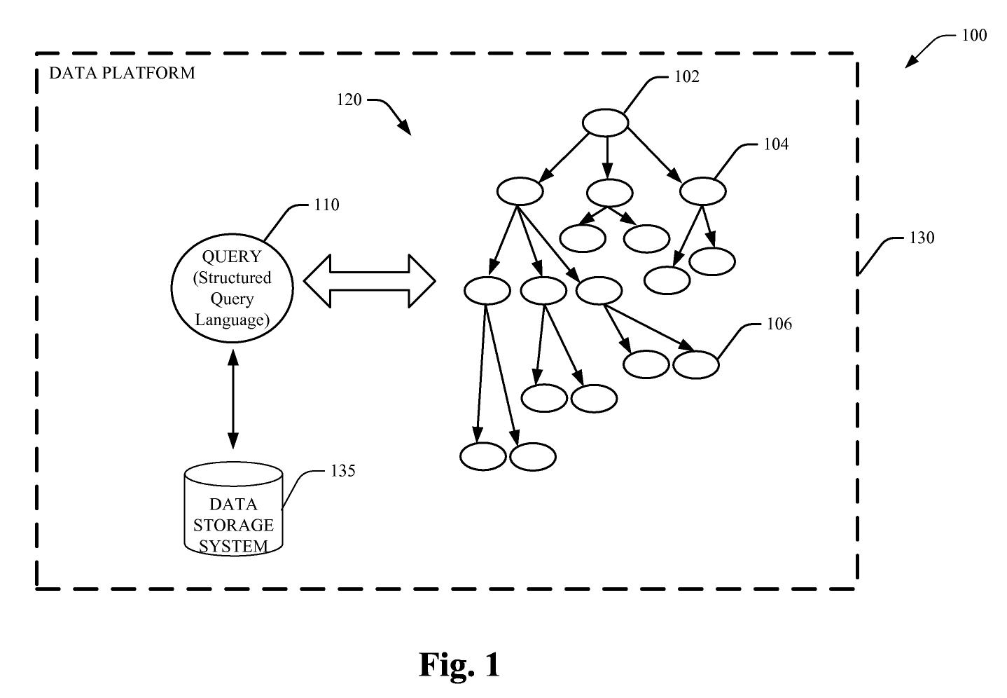

FIG. 1 illustrates a block diagram of a canonical representation in a structured form of a query, in accordance with an aspect of the subject innovation. The canonical representation 100 is in form of a tree structure 120 with nodes 102, 104, 106 with metadata tied thereto, to represent a structured form of the query 110. The canonical representation is in a structured form of a query, against a data model platform 130, such as a base class library that is employed to access data in a relational database system (e.g. an ADO.net framework). An exemplary data model 100 and related data support mechanisms can be implemented into a set of technologies such as the Active X Data Objects for managed code (ADO.NET) platform. Such ADO.net platform can be designed to provide consistent access to data sources such as MICROSOFT® Structured Query Language (SQL) Server, as well as data sources that can be exposed through Object Linking and Embedding for Databases (OLE DB) and Extensible Markup Language (XML). Data-sharing consumer applications can also employ ADO.NET to connect to these data sources and retrieve, manipulate, and update data. The tree structure 120 functions as a canonical tree representation of the query 110, which enables translation into Structured Query Language (SQL) and/or facilitates direct comprehension by an associated data storage system 135 (e.g., typically without translation into a textual format).

Such data storage system 135 can be a complex model based at least upon a database structure, wherein an item, a sub-item, a property, and a relationship are defined to allow representation of information within a data storage system as instances of complex types. For example, the data storage system 135 can employ a set of basic building blocks for creating and managing rich, persisted objects and links between objects. An item can be defined as the smallest unit of consistency within the data storage system 135, which can be independently secured, serialized, synchronized, copied, backup/restored, and the like. Such item can include an instance of a type, wherein all items in the data storage system 135 can be stored in a single global extent of items. The data storage system 135 can be based upon at least one item and/or a container structure. Moreover, the data storage system 135 can be a storage platform exposing rich metadata that is buried in files as items. The data storage system 135 can include a database, to support the above discussed functionality, wherein any suitable characteristics and/or attributes can be implemented. Furthermore, the data storage system 135 can employ a container hierarchical structure, wherein a container is an item that can contain at least one other item. The containment concept is implemented via a container ID property inside the associated class. A store can also be a container such that the store can be a physical organizational and manageability unit. In addition, the store represents a root container for a tree of containers with nodes in the hierarchical structure.

As illustrated in FIG. 1, the nodes 102, 104, 106 can represent various relational and Entity constructs and operations such as expressions. Typically, an expression forms a building block for the tree structure of the subject innovation, and can represent a computation including constants, variables, functions, constructors and standard relational operators like filter, join, and the like—(every expression can have a data type, which represents the type of the result produced by that expression.)

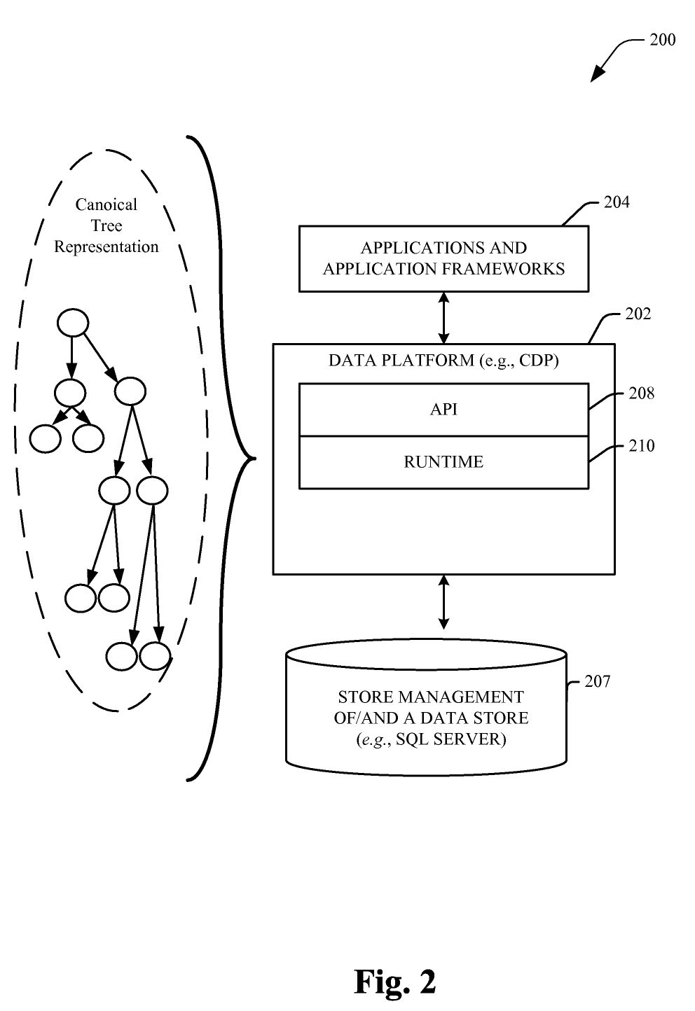

FIG. 2 illustrates a system 200 that can employ the canonical representation of the subject innovation. The data platform 202 can function as a platform that provides a collection of services/mechanisms for applications to access, manipulate, and manage data that is integrated with the application programming environment. In general, a data platform is a platform that provides a collection of services/mechanisms for applications to access, manipulate, and manage data that is well integrated with the application programming environment. For example, the data model platform 202 can be a common data platform (CDP) that provides data services, which are common across a variety of application frameworks (e.g., PIM (Personal Information Manager) framework, and LOB (Line-of-Business) framework). The range of applications include end-user applications such as Explorer, Mail, and Media applications; Knowledge Worker applications such as Document Management and Collaboration applications; LOB applications such as ERP (Enterprise Resource Planning) and CRM (Customer Relationship Management); Web Applications and System Management applications. In such system 200, a query can be represented by an abstract class in form of a tree structure with nodes, which has metadata tied therewith. Such tree structure 200 functions as a canonical tree representation of the query, which enables translation into Structured Query Language (SQL) and/or facilitates direct comprehension by an associated database (e.g., typically without translation into a textual format).

Accordingly, the CDP 202 provides data services that are common across the application frameworks and end-user applications associated therewith. The CDP 202 further includes an API 208 that facilitates interfacing with the applications and application frameworks 204, and a runtime component 210, for example. The API 208 provides the programming interface for applications using CDP in the form of public classes, interfaces, and static helper functions. The CDP runtime component 210 is a layer that implements the various features exposed in the public API layer 208. It implements the common data model by providing object-relational mapping and query mapping, enforcing data model constraints, and the like. More specifically, the CDP runtime 210 can include: the common data model component implementation; a query processor component; a sessions and transactions component; an object cache, which can include a session cache and an explicit cache; a services component that includes change tracking, conflict detection; a cursors and rules component; a business logic hosting component; and a persistence and query engine, which provides the core persistence and query services. Internal to persistence and query services are the object-relational mappings, including query/update mappings.

The store management layer 207 provides support for core data management capabilities (e.g., scalability, capacity, availability and security), wherein the CDP 202 supports a rich data model, mapping, querying, and data access mechanisms for the application frameworks 204. The CDP mechanisms are extensible so that multiple application frameworks 204 can be built on the data platform. The application frameworks 204 are additional models and mechanisms specific to application domains (e.g., end-user applications and LOB applications). Such layered architectural approach supplies several advantages, e.g., allowing each layer to innovate and deploy independently and rapidly.

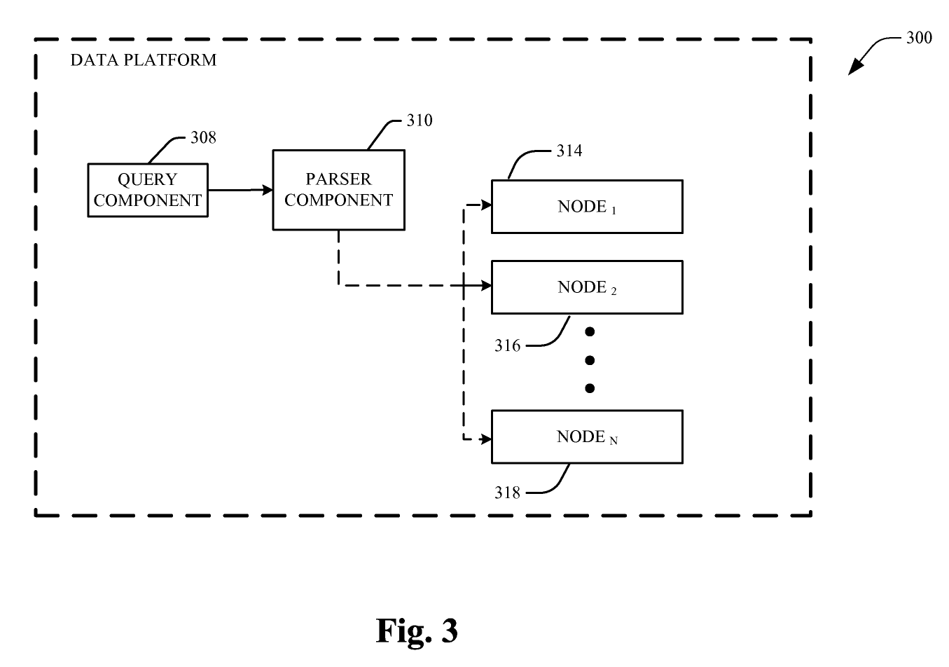

FIG. 3 illustrates a parser component 310 that facilitates formation of the canonical representation in accordance with an aspect of the subject innovation. The parser component 310 can parse the SQL query to generate the abstract class that represent the query (command tree). As such, a plurality of nodes 314, 316, 318 can be obtained that form the canonical representation, which represent a structured form of the query. Subsequently, the nodes can represent various relational and Entity constructs and operations such as expressions. Typically, an expression forms a building block for the tree structure of the subject innovation, and can represent a computation including constants, variables, functions, constructors and standard relational operators like filter, join, and the like—(every expression can have a datatype, which represents the type of the result produced by that expression.)

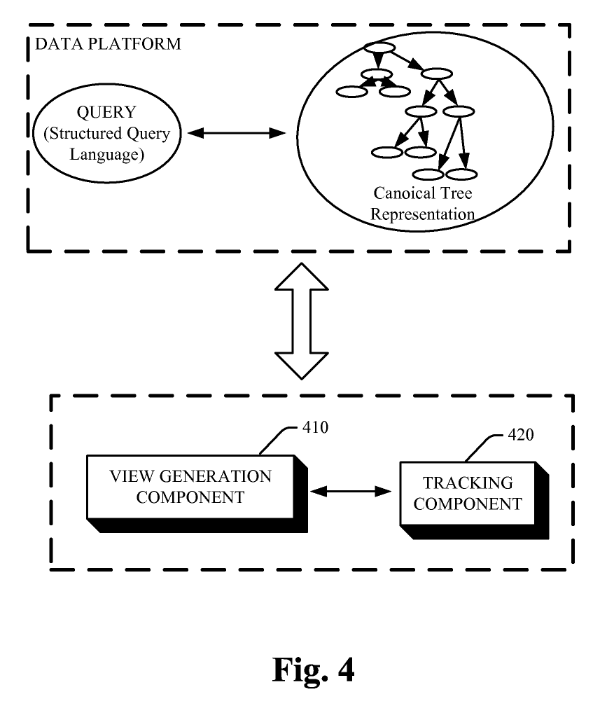

FIG. 4 illustrates a further aspect of the subject innovation, wherein a view generation component 410 can supply a mapping between a rich structure (e.g., on the client side) and the relational side. Such mapping transformation encapsulates object relational mapping functionality and can perform a query translation on the canonical tree of the subject innovation.

Hence, a standard manner of query representation is provided to generate an SQL for the .NET framework, for example. In addition, a tracking component 420 can track changes to the command tree to indicate a last time modification occurred thereon (e.g., via a monotonically increasing version number.) Accordingly, the canonical tree of the subject innovation represents an object model representation of a query in a given metadata space that can be employed to represent Query, Update, Insert and Delete commands.

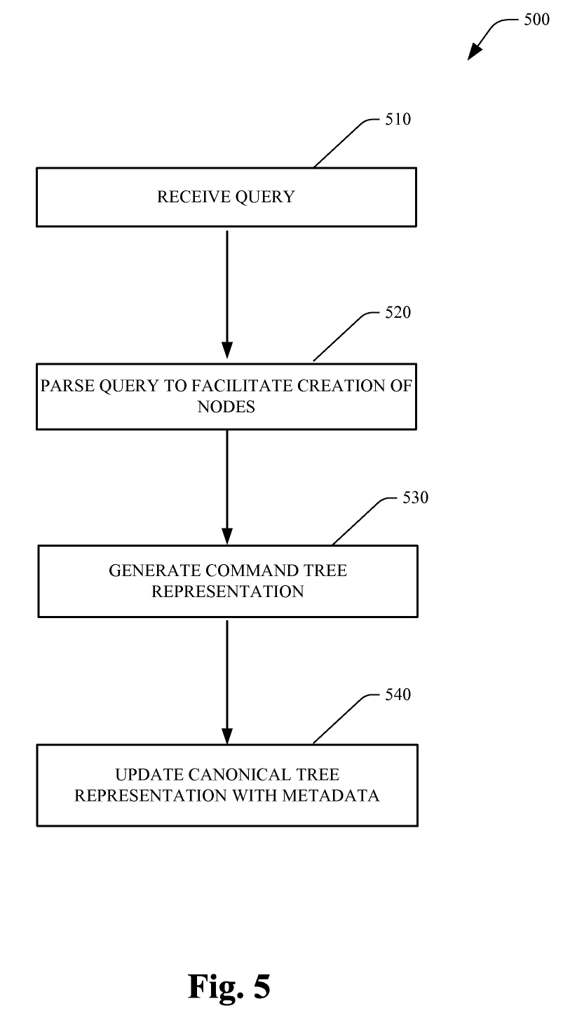

FIG. 5 illustrates a methodology of forming canonical representation in accordance with an exemplary aspect of the subject innovation. While the exemplary method is illustrated and described herein as a series of blocks representative of various events and/or acts, the subject innovation is not limited by the illustrated ordering of such blocks. For instance, some acts or events may occur in different orders and/or concurrently with other acts or events, apart from the ordering illustrated herein, in accordance with the innovation. In addition, not all illustrated blocks, events or acts, may be required to implement a methodology in accordance with the subject innovation. Moreover, it will be appreciated that the exemplary method and other methods according to the innovation may be implemented in association with the method illustrated and described herein, as well as in association with other systems and apparatus not illustrated or described. Initially, and at 510 a query is received as part of an operation associated with a data model platform. Subsequently and at 520, the query can be parsed to facilitate creation of nodes for a tree structure, which functions as a canonical tree representation of the query. As such, a plurality of nodes can be obtained that form the canonical representation, which represent a structured form of the query. Moreover, the nodes can represent various relational and Entity constructs and operations such as expressions. Next and at 530, a command tree can be generated and passed to the view generation component, which then accesses metadata as needed to validate and update the command tree with appropriate metadata, at 540. It is to be appreciated that the Command Tree of the subject innovation also supports the capability of traversing and inspecting each node, and optionally replacing such node with another node.

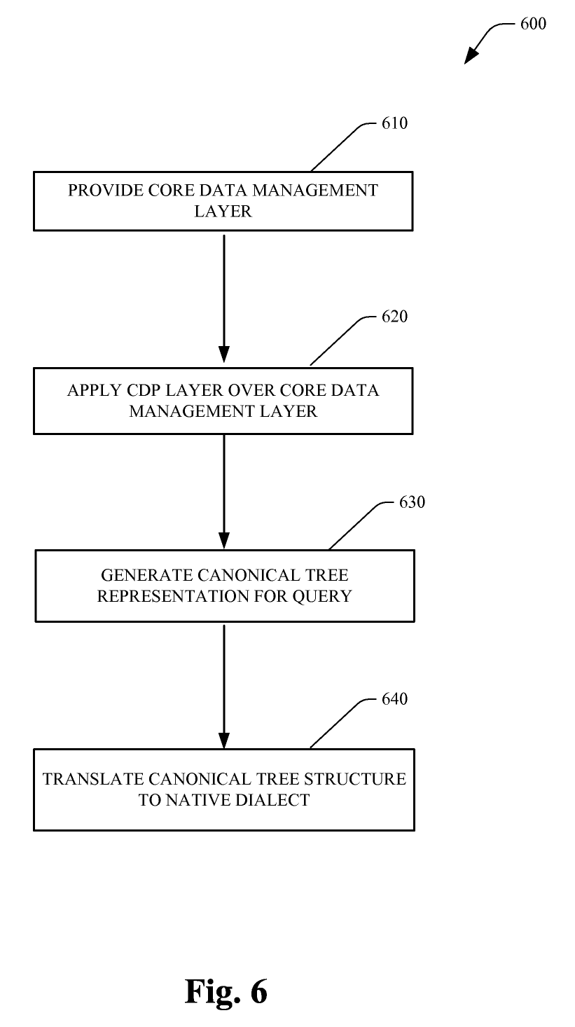

FIG. 6 illustrates a related methodology 600 in accordance with a further aspect of the subject innovation. Initially, and at 610 a core data management layer is provided that models and stores structured, semi-structured and unstructured data types in a data store. At 620, a CDP layer is applied over the core data management layer to provide data services that support a rich data model, mapping, querying, and data access mechanisms for application frameworks. At 630, a canonical tree representation for a query is provided, which enables translation into Structured Query Language (SQL) and/or facilitates direct comprehension by an associated data storage system (e.g., typically without translation into a textual format). At 640, the data storage system and/or store provider translates the canonical tree into its native query language, for example, into a SQL dialect.

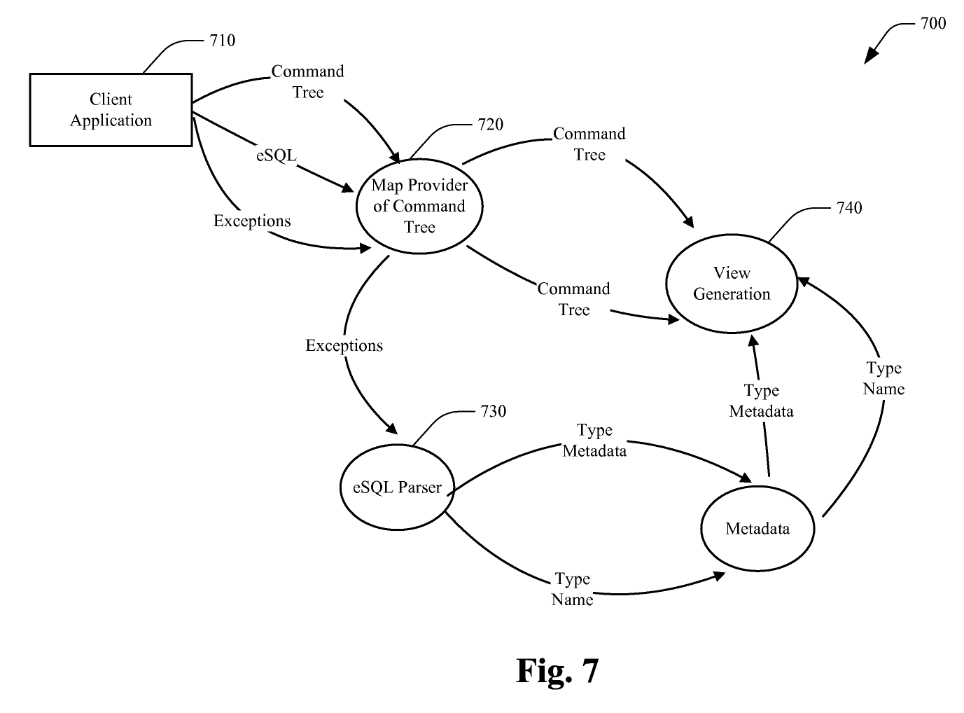

FIG. 7 illustrates an exemplary implementation 700 of an abstract class that represents the query (command tree) in accordance with an aspect of the subject innovation. The client application 710 issues a query against the map provider component 720, or as an eSQL query, Canonical Query Tree (CQT) or as Language Integrated Query (LINQ) expressions. The Map Provider component 720 can subsequently call the eSQL parser 730 to convert the eSQL into a CQT as required. Moreover, the Map Provider Component 720 can also convert the LINQ expressions into CQTs. The CQT can then be passed to the View Generation/Expansion component 740 that access metadata as needed to validate and update the CQT with appropriate metadata. The CQT can then be returned to the Map Provider component 720 that creates a Command Definition from the CQT, wherein a Plan Compiler (not shown) can be called to perform transformations and simplifications on the expressions in the CQT. The result of such transformations can be in form of a number of simplified CQTs that represent the original CQT; as well as assembly information needed on the results assembly component to stitch results back together post execution (not shown). The CQT(s) can then be passed to the Storage Provider. The Storage provider can then walk the CQTs and translates the expressions (nodes of the tree) into its native (SQL) dialect. The SQL can then be executed. Accordingly, the canonical tree of the subject innovation represents an object model representation of a query in a given metadata space that can further be employed to represent Query, Update, Insert and Delete commands.

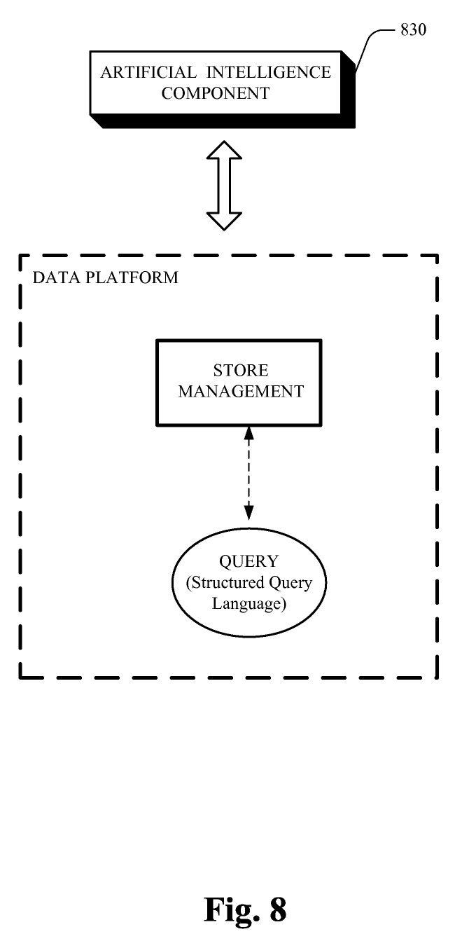

FIG. 8 illustrates an artificial intelligence (AI) component 830 that can be employed to facilitate inferring and/or determining when, where, how to generate a canonical tree structure in accordance with an aspect of the subject innovation. As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

The AI component 830 can employ any of a variety of suitable AI-based schemes as described supra in connection with facilitating various aspects of the herein described invention. For example, a process for learning explicitly or implicitly how a node associated with the canonical tree structure should be generated can be facilitated via an automatic classification system and process. Classification can employ a probabilistic and/or statistical-based analysis (e.g., factoring into the analysis utilities and costs) to prognose or infer an action that a user desires to be automatically performed. For example, a support vector machine (SVM) classifier can be employed. Other classification approaches include Bayesian networks, decision trees, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information) so that the classifier is used to automatically determine according to a predetermined criteria which answer to return to a question. For example, with respect to SVM's that are well understood, SVM's are configured via a learning or training phase within a classifier constructor and feature selection module. A classifier is a function that maps an input attribute vector, x=(x1, x2, x3, x4, xn), to a confidence that the input belongs to a class—that is, f(x)=confidence(class).

A particular implementation for an exemplary command tree can serve both as a representation of a command as well as a factory for building up expressions, for example;

```
{
    // the metadata workspace
    public MetadataWorkspace MetadataWorkspace { get; }
    // clone methods
    public abstract CommandTree Clone( ) {...}
    // import an expression into this command tree
    public Expression Import(Expression source) {...}
    // validation
    public void Validate( ) { }
    // Add a new parameter
    public void AddParameter(string name, TypeMetadata type) {...}
    // Get list of parameters
    public IEnumerable<KeyValuePair<string, TypeMetadata>>
      Parameters {get;}
    // Change tracking
    public int VersionNumber { get;}
    // Various expression builder methods - described later
    ...
  }
```

wherein, the MetadataWorkspace property returns the metadata workspace employed for such command tree. Moreover, the Validate method validates the command tree, and raises an exception if the command tree has any errors (or is incomplete). The Clone method clones a command tree, and the Import method imports an expression (copies it) into the current command tree. Likewise, the VersionNumber property returns a current version of the command tree.

In one aspect, the initial version of the command tree (after creation) can be zero, and any subsequent modifications increaes the version number. For example, such can be employed by consumers of the tree that need to determine whether such tree has changed since last time. Moreover, the AddParameter method can add a new parameter to the commandtree. The Parameters property returns a list of parameters employed in such command tree.

The various subclasses of CommandTree are described below:

QueryCommandTree

The QueryCommandTree describes a query, wherein the QueryCommandTree constructor creates a new instance of the QueryCommandTree. The Query property describes the root of the expression tree that defines the query, and the Query property can be set (or read)—the CommandTree is in an invalid state until the Query property is set to a valid state.

```
public class QueryCommandTree : CommandTree
  {
    public QueryCommandTree(MetadataWorkspace
    metadataWorkspace);
    public Expression Query { get; set;}
  }
```

FunctionCommandTree

FunctionCommandTree can represent an invocation of a store function/procedure. Such commandtree is invalid until it is initialized, and typically all mandatory properties have been set.

```
public class FunctionCommandTree : CommandTree
  {
    public FunctionCommandTree(
      MetadataWorkspace metadataWorkspace);
    public IFunctionMetadata Function { get; set;}
  }
```

It is to be appreciated that Function parameters can be represented by command tree parameters with a same name.

As explained earlier, one particular fundamental building block of the canonical query tree is an Expression. The Expression abstract base class can be subclassed to provide various flavors of expressions, for example;

```
public abstract class Expression
  {
    public TypeMetadata Type {get;}
    public ExpressionKind ExpressionKind { get ;}
    public CommandTree CommandTree { get; }
    // clone mechanisms
    public object Clone( ) {...}
    // Visitors
    public virtual void Visit(IExpressionVisitor v) { ...}
    public virtual T Visit<T>(IExpressionVisitor<T> v) {...}
  }
```

CommandTree

Every expression can be created in a CommandTree. In general, all expressions in a tree belong to the same CommandTree. Such CommandTree provides additional state for various operations including validation.

ExpressionKind

The ExpressionKind enum describes the various kinds of expressions.

```
/// <summary>
  /// Describes the different “kinds” (classes) of expressions
  /// </summary>
  public enum ExpressionKind
  {
    Constant,
    ParameterRef,
    VarRef,
    Function, Property,
    Treat, IsOf, Cast,
    Case,
    Plus, Minus, UnaryMinus, Multiply, Divide, Modulo,
    Union, Intersect, Except, Distinct, Element, IsEmpty, OfType,
    Equals, NotEquals, LessThan, GreaterThan,
    LessThanEquals, GreaterThanEquals,
    And, Or, Not, IsNull,
    Like,
    NewInstance,
    GetEntityRef,
    GetRefKey,
    Extent, View,
    Ref,
    Deref,
    RelationshipNavigation,
    // Relational operators
    Filter,
    Project,
    Join,
    Sort,
    GroupBy,
    Apply,
    // Misc
    Any,
    All
  }
```

Type

Such property can define the datatype of an Expression. The datatype of an expression can be set during construction. An attempt to modify the Type property can subsequently result in an exception.

Clone

Such method clones an expression (tree).

Visitors

Two visitor interfaces can be provided for expressions.

Extensibility

Expressions are extensible, wherein new subclasses of expressions can be created.

Abstract Expression Classes

In general, UnaryExpression, BinaryExpression, NaryExpression represent helper base classes upon which many of the subsequent classes can be built, for example:

```
public abstract class UnaryExpression : Expression
    {
      public Expression Argument { get ; set; }
    }
    public abstract class BinaryExpression : Expression
    {
      public Expression Left { get ; set;}
      public Expression Right { get ; set;}
    }
    public abstract class NaryExpression : Expression
    {
      public IList<Expression> Arguments { get ;}
    }
```

Expression Helper Classes

Typically, an ExpressionBinding is similar to a for each traversal with a binding to each element of the traversal. Such class can be provided as a helper class for many of the expressions that correspond to relational operators—Filter, Project, and the like, for example:

```
public class ExpressionBinding
    {
      public VarRefExpression Var { get ; }
      public string VarName { get ;}
      public TypeMetadata VarType { get ;}
      public Expression Expression { get; set; }
    }
```

The Expression property can represents the collection being iterated over. The Var property represents a new variable reference, wherein such variable represents a new value produced by iterating over the collection input, and can be referenced later by a corresponding VarRefExpression. The VarType and VarName properties represent the type and the name of the Var.

GroupExpressionBinding

A GroupExpressionBinding is a specialized binding suitable for use by a GroupByExpression.

```
public class GroupExpressionBinding
    {
      public VarRefExpression Var { get ; }
      public string VarName { get ;}
      public TypeMetadata VarType { get ;}
      public Expression Expression { get; set; }
      public string GroupVarName { get ;}
      public VarRefExpression GroupVar { get ; }
      public TypeMetadata GroupVarType { get ;}
    }
```

The Group Var property represents a variable reference to the result of the grouping, and can only be used in aggregates. The Group VarType and Group VarName properties describe the type and name of the GroupVar.

Aggregate, FunctionAggregate

In general, Aggregate is an abstract base class to represent aggregates in a group-by clause. FunctionAggregate is a concrete subclass that handle standard aggregate functions.

```
public abstract class Aggregate
{
  public IList<Expression> Arguments { get ; }
  public TypeMetadata ResultType { get; }
}
public class FunctionAggregate : Aggregate
{
  public IFunctionMetadata Function { get ; }
  public bool Distinct { get ; }
}
```

Aggregates can resemble Expressions. The Arguments property of Aggregate describe the arguments to the aggregate, while the ResuitType property describes the result type of the aggregate.

The Distinct property of the FunctionAggregate indicates if the aggregate is a distinct aggregate, e.g., if duplicates in the input arguments must be eliminated first before the aggregate is computed.

SortSpec

Typically, a SortSpec defines a sort key for a SortExpression. The SortSpec can include the expression being sorted, whether one needs an ascending/descending sort, and a collation string (typically valid for string datatype expressions), for example:

```
public class SortSpec
  {
    public Expression Expression { get; set;}
    public bool Ascending { get; }
    public string Collation {get;}
  }
```

LambdaFunction

A LambdaFunction can represent an inline (lambda) function, and can be used in a FunctionExpression instead of a regular function.

```
public class LambdaFunction : IFunctionMetadata
  {
    public Expression Body { get; set; }
  }
```

Likewise, Concrete Expression Subclasses can include:

ConstantExpression

A Constant, as the name might suggest, represents different kinds of constants (literals).

public class ConstantExpression : Expression
{
public object Value { get; }
}

NullExpression

A NullExpression can represent a reference to a typed null literal.

public class NullExpression : Expression
{
}

VarKetlxpression

A VarRefExpression represents a reference to a variable defined earlier in the query.

public class VarRefExpression : Expression
{
public string Name { get; }
}

ParameterRefExpression

A ParameterRefExpression represents a reference to a query parameter (ie) a variable defined outside the bounds of the query.

```
public class ParameterRefExpression : Expression
  {
    public string Name { get; }
  }
```

FunctionExpression

A FunctionExpression represents the invocation of a standalone function. The IsLambdaFunction property describes if the function is a lambda function.

```
public class FunctionExpression : Expression
{
  public IFunctionMetadata Function { get;}
  public IList<Expression> Arguments { get;}
  public bool IsLambdaFunction { get; set;}
}
```

PropertyExpression

A PropertyExpression represents a property reference from an expression (whose type is a record, entity type, or complex type).

```
public class PropertyExpression : Expression
{
  public PropertyMetadata Property { get; }
  public Expression Instance { get; set; }
}
```

ComparisonExpression

Represents various kinds of comparisons—equality, less than, greater than, and the like. Each of the comparison operators can be represented by the appropriate ExpressionKind.

public class ComparisonExpression: BinaryExpression { }

ArithmeticExpression

Represents the various arithmetic operations (+, −, *, /, %)

public class ArithmeticExpression: NaryExpression { }

Boolean Connectors

Represents and/or/not expressions.

public class AndExpression : BinaryExpression { }
public class OrExpression : BinaryExpression { }
public class NotExpression : UnaryExpression { }

IsNullExpression

Represents a null test.

public class IsNullExpression: UnaryExpression { }

CaseExpression

Represents a Sql switched-case (Lisp Cond) expression.

```
public class CaseExpression : Expression
{
  public IList<Expression> When { get ;}
  public IList<Expression> Then { get;}
  public Expression Else { get ; set;}
}
```

UnionAllExpression, IntersectExpression, ExceptExpression, DistinctExpression, ElementExpression, IsEmptyExpression, OfFypeExpression

Such can represent corresponding set operators, wherein UnionAII represents the union (with no duplicate elimination) of two collections; Intersect describes the intersection of two collections; Except represents the (one-way) difference of two collections; Distinct removes duplicates from an input collection; Element obtains the single element of an input collection. Such element operator in eSQL logically returns the single element of the collection if the collection has exactly one element, null if the collection is empty, and raises an exception otherwise.

Likewise, IsEmpty checks to see if a collection is empty. Similarly, Oftype probes a collection for elements of a specific type, and returns the subset of elements of that type (suitably upcast). OfType(X, T) is syntactic sugar for “select item treat(x as T) from X as x where x is of T”. As with Treat, the specified type must be a nominal type (complextype/entity type), and the element type of the collection expression can be (statically) a subtype/supertype of the specified type, for example:

public class UnionAllExpression : BinaryExpression { }
public class IntersectExpression : BinaryExpression { }
public class ExceptExpression : BinaryExpression { }
public class DistinctExpression : UnaryExpression { }
public class ElementExpression : UnaryExpression { }
public class IsEmptyExpression : UnaryExpression { }
public class OfTypeExpression : UnaryExpression
{
public TypeMetadata OfType {get;}
}

As such a canonical query tree for the following query

```
(select p.age, p.name
  from Person as p
  where p is of Customer)
union all
  multiset(row(12 as age, “minor” as name))
```

can be constructed as follows:

```
  QueryCommandTree qt = new QueryCommandTree
  (metadataWorkspace);
  Expression e1 = null;
  Expression e2 = null;
  // Build up the first branch of the union all
  {
    Extent personExtent =
      metadataWorkspace.GetExtentMetadata(“Person”);
    TypeMetadata customerType = metadataWorkspace.-
    GetType(“Customer”);
    Expression fromExpression =
qt.CreateExtentExpression(personExtent);
    // build up the where clause
    ExpressionBinding wb =
      qt.CreateExpressionBinding(fromExpression);
    ExpressionBinding
    Expression wherePredicate = qt.createIsOfExpression(wb.Var,
                              customerType);
    Expression filterExpr = qt.CreateFilterExpression(
      wb, wherePredicate);
    // Build up the projection clause now
    ExpressionBinding sb = qt.CreateExpressionBinding(filterExpr);
    List<KeyValuePair<string, Expression>> projFields =
      new List<KeyValuePair<string, Expression>>( );
    Expression ageField = qt.CreatePropertyExpression(“age”, sb.Var);
    Expression nameField = qt.CreatePropertyExpression(“name”,
sb.Var);
    projFields.Add(new KeyValueValuePair<string, Expression>(
                      “age”, ageField));
    projFields.Add(new KeyValueValuePair<string, Expression>(
                      “name”, nameField));
    Expression projection = qt.CreateNewRowExpression(projFields);
    Expression projExpr = qt.CreateProjectExpression(sb, projection);
    e1 = projExpr;
  }
  // Build up the second branch of the union all
  {
    List<KeyValuePair<string, Expression>> projFields =
      new List<KeyValuePair<string, Expression>>( );
    Expression ageField = qt.CreateConstantExpression(12);
    Expression nameField = qt.CreateConstantExpression(“minor”);
    projFields.Add(new KeyValueValuePair<string, Expression>(
                      “age”, ageField));
    projFields2.Add(new KeyValueValuePair<string, Expression>(
                      “name”, nameField));
    Expression recExpr = qt.CreateNewRowExpression(projFields);
    IList<Expression> multisetArgs = new List<Expression>( );
    multisetArgs.Add(recExpr);
    e2 = qt.CreateNewCollectionExpression(multisetArgs);
  }
  // Now build up the combined expression
  Expression queryExpr = qt.CreateUnionAllExpression(e1, e2);
  // Finally, initialize the query command tree
  qt.Query = queryExpr;
  // Return the constructed query command tree
  return qt;
}
```

The word “exemplary” is used herein to mean serving as an example, instance or illustration. Any aspect or design described herein as “exemplary” is not necessarily to be construed as preferred or advantageous over other aspects or designs. Similarly, examples are provided herein solely for purposes of clarity and understanding and are not meant to limit the subject innovation or portion thereof in any manner. It is to be appreciated that a myriad of additional or alternate examples could have been presented, but have been omitted for purposes of brevity.

Furthermore, all or portions of the subject innovation can be implemented as a system, method, apparatus, or article of manufacture using standard programming and/or engineering techniques to produce software, firmware, hardware or any combination thereof to control a computer to implement the disclosed innovation. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

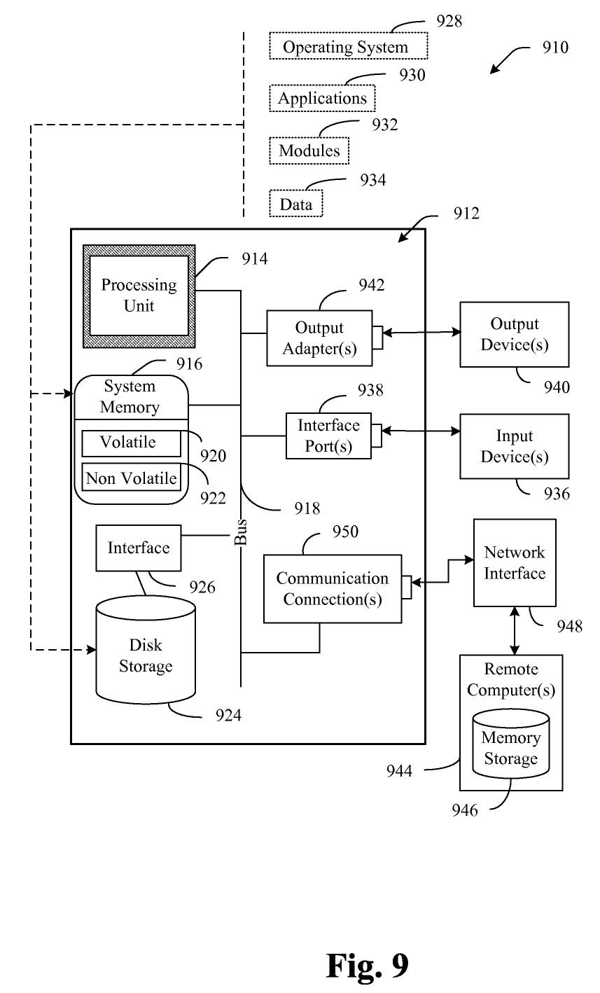

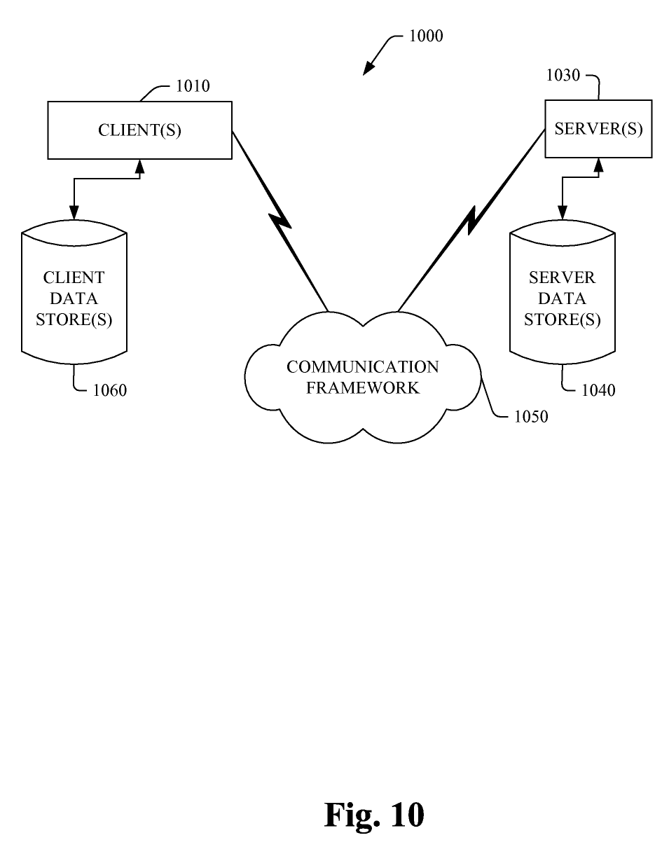

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the innovation also may be implemented in combination with other program modules. Generally, program modules include routines, programs, components, data structures, and the like, which perform particular tasks and/or implement particular abstract data types. Moreover, those skilled in the art will appreciate that the innovative methods can be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the innovation can be practiced on stand-alone computers. In a distributed computing environment, program modules may be located in both local and remote memory storage devices.

As used in this application, the terms “component”, “system”, “engine” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Generally, program modules include routines, programs, components, data structures, and the like, which perform particular tasks and/or implement particular abstract data types. Moreover, those skilled in the art will appreciate that the innovative methods can be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the innovation can be practiced on stand-alone computers. In a distributed computing environment, program modules may be located in both local and remote memory storage devices.

With reference to FIG. 9, an exemplary environment 910 for implementing various aspects of the subject innovation is described that includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable ROM (EEPROM), or flash memory. Volatile memory 920 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also includes removable/non-removable, volatile/non-volatile computer storage media. FIG. 9 illustrates a disk storage 924, wherein such disk storage 924 includes, but is not limited to, devices like a magnetic disk drive, floppy disk drive, tape drive, Jaz drive, Zip drive, LS-60 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in suitable operating environment 910. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that various components described herein can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 912 to an output device 940. Output adapter 942 is provided to illustrate that there are some output devices 940 like monitors, speakers, and printers, among other output devices 940 that require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

FIG. 10 is a schematic block diagram of a sample-computing environment 1000 that can be employed for implementing the command tree of the subject innovation. The system 1000 includes one or more client(s) 1010. The client(s) 1010 can be hardware and/or software (e.g., threads, processes, computing devices). The system 1000 also includes one or more server(s) 1030. The server(s) 1030 can also be hardware and/or software (e.g., threads, processes, computing devices). The servers 1030 can house threads to perform transformations by employing the components described herein, for example. One possible communication between a client 1010 and a server 1030 may be in the form of a data packet adapted to be transmitted between two or more computer processes. The system 1000 includes a communication framework 1050 that can be employed to facilitate communications between the client(s) 1010 and the server(s) 1030. The client(s) 1010 are operatively connected to one or more client data store(s) 1060 that can be employed to store information local to the client(s) 1010. Similarly, the server(s) 1030 are operatively connected to one or more server data store(s) 1040 that can be employed to store information local to the servers 1030.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims.

Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer implemented system comprising the following computer executable components:
a query; and
a canonical representation of the query against a data model platform.

2. The computer implemented system of claim 1, the canonical representation in form of a tree structure with nodes.

3. The computer implemented system of claim 1, the canonical representation translatable into a structured query language.

4. The computer implemented system of claim 1 further comprising a parser component that parses the query to generate an abstract class that forms the canonical representation.

5. The computer implemented system of claim 4 further comprising a tracking component that tracks changes to the canonical representation.

6. The computer implemented system of claim 2 further comprising a metadata space that presents an object model of the query.

7. The computer implemented system of claim 6, a Query, Update, Insert and Delete command presentable by the metadata space.

8. The computer implemented system of claim 6 further comprising a Data Manipulation Language that employs a non-textual form for query representation.

9. The computer implemented system of claim 2 further comprising relational and Entity constructs represented by the nodes.

10. The computer implemented system of claim 4 further comprising a view generation component that performs query translations on the canonical representation.

11. A computer implemented method comprising the following computer executable acts:
forming a query as entity constructs; and
representing the query in canonical form against a data model platform.

12. The computer implemented method of claim 11 further comprising parsing the query to obtain a plurality of nodes.

13. The computer implemented method of claim 11 further comprising accessing metadata to validate the canonical form.

14. The computer implemented method of claim 11 further comprising translating the canonical form into SQL language.

15. The computer implemented method of claim 11 further comprising tracking changes to the canonical form.

16. The computer implemented method of claim 11 further comprising supporting a rich data model for application frameworks that issue the query.

17. The computer implemented method of claim 11 further comprising updating the canonical form with metadata associated with the query.

18. The computer implemented method of claim 11 further comprising representing the query as an object model.

19. The computer implemented method of claim 12 further comprising traversing the plurality of nodes for an optional replacement of a node with another node.

20. A computer implemented system comprising the following computer executable components:
means for representing a query as an object model; and
means for tracking the query in the object model.
